(19) United States
(12) Patent Application Publication
(10) Pub. No.: US 2005/0155077 A1
(43) Pub. Date: Jul. 14, 2005

(54) Media on-demand systems

(75) Inventors: Jeffrey Lawrence, Boston, MA (US); Tracy Lawrence, Boston, MA (US)

Correspondence Address: FISH & NEAVE IP GROUP;ROPES & GRAY LLP, ONE INTERNATIONAL PLACE, BOSTON, MA, 02110-2624, US

(73) Assignee: MediaMall Technologies

(21) Appl. No.: 10/753,612

(22) Filed: Jan. 8, 2004

(51) Int. Cl. H04N 7/173

(52) U.S. Cl. 725/109; 725/110; 725/112; 725/135

(57) ABSTRACT

A home system for on-demand media advantageously employs hardware already present in a typical consumer's home to reduce the cost and complexity of an on-demand controller. The controller may use a pre-existing network connection to access media sources on the Internet or other data networks, and may use mass storage available on the consumer's computer or elsewhere in the user's household to store media for streaming to a television or other display device. The controller coordinates operation of these components to provide an on-demand media experience to a user.

### BACKGROUND OF THE INVENTION

1. Field of the Invention

The present invention relates to media on-demand systems, and more particularly to systems for managing remote, on-demand content at a viewer location.

2. Description of the Related Art

Advances in telecommunications and cable networks have brought broadband capabilities to the average consumer, and enabled a host of new computer and television applications. For televisions in particular, the greater information carrying capacity of the cable TV infrastructure has multiplied the number of available broadcast channels, and video on-demand is becoming available in several areas.

In addition to the increase in available bandwidth, an increase in local processing power have given rise to richer applications at the consumer's end location, such as TiVo, which locally records broadcast media for replay at the consumer's convenience. More complex functions and greater selection have generally been the hallmarks of advances in network technology, processor capability, and the convergence of data, cable, and telecommunications networks.

As a significant disadvantage, new consumer media solutions typically provide out-of-the-box products that integrate numerous components already present in the consumer's home. This can significantly raise the cost of a system by requiring duplicative purchases of such components as processors, mass storage, and network interfaces. Further inefficiencies may be created by forcing a consumer into particular hardware selections that the consumer might otherwise not choose.

There remains a need for an inexpensive home infrastructure for participating in on-demand media services.

### SUMMARY

A home system for on-demand media advantageously employs hardware already present in a typical consumer's home to reduce the cost and complexity of an on-demand controller. The controller may use a pre-existing network connection to access media sources on the Internet or other data networks, and may use mass storage available on the consumer's computer or elsewhere in the user's household to store media for streaming to a television or other display device. The controller coordinates operation of these components to provide an on-demand media experience to a user.

### BRIEF DESCRIPTION OF THE DRAWINGS

The present disclosure may be better understood and its numerous features and advantages made apparent to those skilled in the art by referencing the accompanying drawings wherein:

FIG. 1 is a block diagram of an on-demand media system;

FIG. 2 is a block diagram of a set-top box for use with the on-demand media system;

FIG. 3 is a block diagram of an on-demand media system; and

FIG. 4 is a flow chart showing operation of a controller for an on-demand media system.

### DETAILED DESCRIPTION

Described herein are systems and methods for providing an on-demand media system. However, it will be appreciated that the principles of this system may be adapted to other applications where hardware components distributed throughout a household may be usefully combined to perform an integrated function. These and other applications not specifically described below are intended to fall within the scope of the systems and methods disclosed herein.

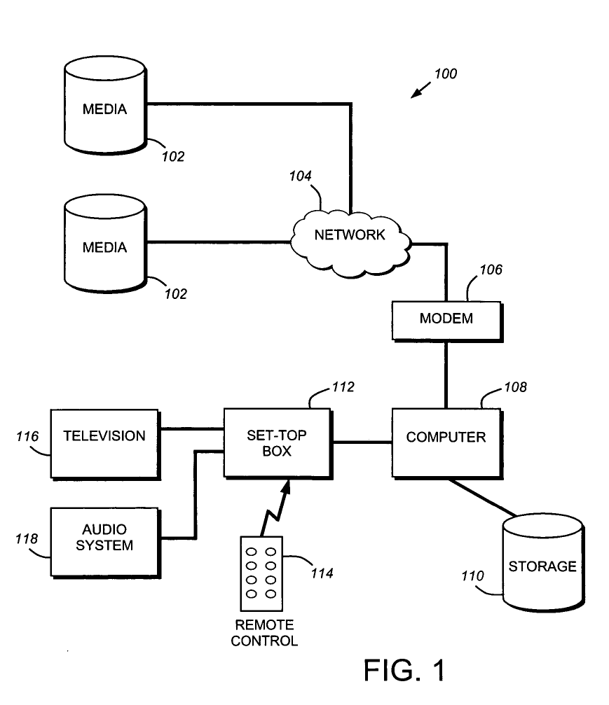

FIG. 1 is a block diagram of an on-demand media system. The system may include one or more remote servers 102 storing media, a network 104, a modem 106, a computer 108 having a storage device 110, a set-top box 112, a remote control 114, a television 116, and an audio system 118.

The remote servers 102 may be any servers connected to the network 104 and capable of providing content in digital or other form over the network 104. The remote servers 102 may be configured, for example, as web servers responding to HyperText Transfer Protocol (“HTTP”) requests, file servers responding to File Transfer Protocol (“FTP”) requests, Gnutella servlets or similar peer-to-peer configurations, or any other form of server or other device operating on a conventional or proprietary standard to provide data over the network 104. The remote servers 102 may store content (also referred to generally herein as “media”) organized as one or more files, and may include relational or other databases to manage and locate stored media in response to requests received over the network 102. These or other devices suitable for providing access to data over the network 104 may be usefully employed with the systems described herein.

The media stored on the remote servers 102 may include movies, music, news, television shows, games, music videos, sports events, or any other media or other content suitable for transmission over the network and rendering at a user's location. Content may be stored as media files using various known formats such as those conforming to the Moving Picture Expert Group (“MPEG”) media standards or the RealAudio file format. Where the remote servers 102 and the network 104 have suitable capacity, the content may be stored and transferred in a format for direct rendering on the television 116, such as emerging digital high-definition television formats.

The network 104 may include any data, telecommunications, or other network, or combination of networks, suitable for interconnecting the modem 106 with the remote servers 102. For example, the network 104 may carry data over the Internet or other data networks, as well as the Public Switched Telephone Network, or any other public or private networks. The network 104 may also, or instead, employ satellite or cable television networks. Similarly, the so-called “last mile” from a network point-of-presence to the modem 106 may include various one way or bi-directional communication technologies, such as a cable modem, a digital subscriber line (“DSL”) modem, a satellite receiver, or a wireless interface using wireless local area network technologies (e.g., IEEE standards 802.11a, 802.11b, and 802.11g, a.k.a. “Wi-Fi”)) or wireless metropolitan area network technologies (e.g., 802.16a, 802.16d, and 802.16e, a.k.a. “Wi-Max”). These and other networking technologies may be suitably employed with the systems described herein.

The modem 106 may be any transceiver or collection of transceivers or other devices suitable for connecting the computer 108 with the remote servers 102 in a communicating relationship through the network 104. The modem 106 may include, for example, a CCITT V.34 or V.90 modem for transceiving data over a telecommunications link. The modem 106 may instead include a cable modem, DSL modem or other modem or collection of modems suitable for connecting to the network 104 as described above and communicating with the remote servers 102. The modem 106 may also, or instead, include hardware for communicating over an ISDN or T1 connection. It will be appreciated that, while a single modem 106 is depicted, multiple modems may be included with the systems described herein.

It will also be appreciated that, while the modem 106 is depicted as a single unit in FIG. 1, the modem 106 may include multiple hardware components. For example, a cable modem may provide a local connection to the Internet, and the cable modem may in turn connect to a wireless hub that serves as a router to distribute this connection to one or more machines over a wired or wireless local area network. All such devices and configurations may operate as a modem within the systems described herein.

The computer 108 may connect to the network 104 through the modem 106. The computer 108 may be any personal computer, laptop, or other home computing device. The computer 108 may be, for example, an Intel-based desktop computer running a Windows operating system, or a Macintosh or other desktop computer from Apple. The computer may instead be a laptop computer, and may be connected to the modem 106 through a wireless interface. In order for the set-top box 112 to control operation of the computer 108 during operations such as searching and downloading remote content, the computer 108 may execute a remote management program that permits the set-top box 112 to issue commands to the computer through a local area network or other connection.

The storage device 110 may be any storage device built into or externally connected to the computer 108, or a device independent from the computer but stored in the home for the purpose of distributed data storage. For example, the storage device 110 may be an internal or external hard disk drive or an independent storage device of a capacity and speed suitable for storing content downloaded from the remote servers 102. The storage device 110 may also, or instead, include internal or external Compact Disc (“CD”) storage technology using recordable (“CD-R”) or rewriteable (“CD-RW”) CDs and drives, as well as similar Digital Versatile Disc (“DVD”) technologies. These or any other storage technologies having a capacity and speed suitable for storing content from remote servers 102 and playing back content to a television or other output device at suitable speeds may be used as the storage device 110 in the systems described herein. It will be appreciated that, although the storage device 110 is depicted as associated with the computer 108, an independent storage device may also, or instead, be employed.

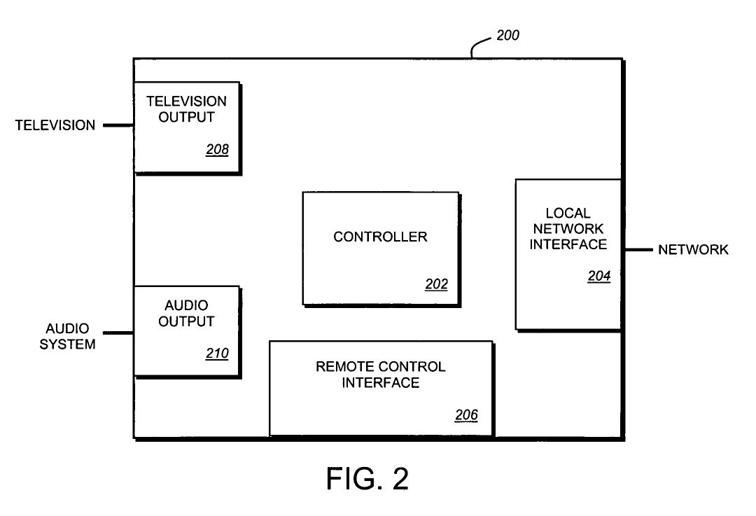

The set-top box 112 may connect the computer 108 to the television 116. In general, the set-top box 112 coordinates operation on an on-demand media system through the architecture depicted in FIG. 1. This may include receiving control signals from a remote control 114 that a user operates, and converting these control signals into operations such as downloading content from the remote servers 102 to the storage device 110, as well as controlling playback of the locally stored content on the television 116 and/or audio system 118. The set-top box may also render a user interface within the signals provided to a television through a television output. The set-top box 112 is described in greater detail in FIG. 2 below.

The remote control 114 may be any device for providing control signals to the set-top box 112. The remote control 114 may include a plurality of buttons, switches, dials, thumb pads, and/or other input devices that receive manual user inputs. These user inputs may be converted into control signals transmitted to the set-top box. The remote control 114 may employ, for example, an infrared air interface for transmitting signals to the set-top box, or a short range radio frequency air interface such as Bluetooth.

The television 116 may receive signals from the set-top box 112 over a digital or analog television connection such as National Television System Committee (“NTSC”) or Phase Alternating Line (“PAL”) compliant signals, as well as more recent high-definition television formats.

The system 100 may include a separate audio system 118 to receive audio signals directly from the set-top box 112, such as MPEG Audio Layer 3 (“MP3”) signals or other analog or digital audio signals. Although not depicted, it will be appreciated that audio output may be provided directly from the television 116 to the audio system 118, although a separate connection from the set-top box 112 to the audio system 118 may simplify rendering of audio-only content such as MP3 files.

It will be appreciated that, in the architecture described above, the modem 106, storage device 110, television 116, and audio system 118 are components commonly found in a consumer household, and the set-top box 112 described herein may advantageously employs these external devices to provide a media on-demand system to a consumer without requiring the purchase of potentially expensive new hardware, such as a storage device.

FIG. 2 is a block diagram of a set-top box for use with the on-demand media system. The set-top box 200, which may be the set-top box 112 of FIG. 1, may include a controller 202, a local network interface 204, a remote control interface 206, a television output 208, and an audio output 210.

The controller 202 may be based upon a microprocessor, microcontroller, or other programmable device or devices, and may employ an operating system such as Windows CE, Windows XP embedded, or Linux. Upon this platform, the controller 202 may be programmed using any programming language or environment suitable for the chosen operating system. The controller 202 may also, or instead, employ application specific integrated circuits, programmable logic devices, or any other integrated circuits or other technology capable of managing the other components of the set-top box 200 and processing user input received from the remote control interface 206. Functions to be coordinated by the controller 202 may include, for example, receiving and interpreting user input from the remote control interface 206, playing content by retrieving data from a storage device through the local network interface 204 and formatting the data for output to the television output 208 or the audio output, and coordinating retrieval of content from the remote servers by providing suitable instructions to a computer or other device through the local network interface 204.

The controller 202 may generate a user interface and embed the interface in signals to the television output. The user interface may occupy the entire television display, or a portion thereof. The interface may displace a portion of the television images that would otherwise appear on a portion of the screen. The interface may be opaque, and completely superimposed upon a portion of the television screen, or be rendered as a partially transparent image blended with underlying visual content in the television signal. User interfaces embedded in television signals are well known and commonly used for televisions, cable television set-top boxes, video cassette recorders, and the like. Such user interfaces and their associated features and functions may be usefully employed with the systems described herein.

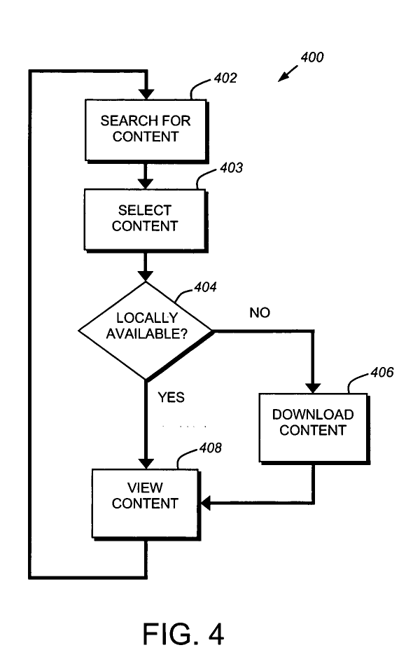

Generally, the controller 202 may coordinate operation of a media on-demand system. Numerous features and functions may be provided with such a system, including searching for local or remote content (or both), browsing content, playing content, including starting, pausing, fast forwarding, reversing, restarting, setting a bookmark and navigating to a bookmark, deleting local content, and so forth. Several of the more important operations, searching and viewing, are described in greater detail below with reference to FIG. 4. In general, implementing these functions will depend on the choice of input, output, network, and storage technologies, and their realization may be readily achieved by one of ordinary skill in the art.

The local network interface 204 may be, for example, a wired ethernet connection (e.g., 10/100 Base-T), a wireless local area network connection such as 802.11a, 802.11b, or 802.11g. In certain embodiments, the “local network” may be a simple peer-to-peer or client/server connection between the set-top box 200 and a computer or other device storing content, using a wireless interface such as Bluetooth or a wired interface such as Universal Serial Bus (“USB”). Of course, the choice of connection type may depend in part upon the bandwidth requirements for uninterrupted delivery of content to the television output 208 or audio output 210.

The remote control interface 206 may employ any suitable short-range wireless interface, such as Bluetooth or infrared, for receiving control signals from a remote control. These signals are forwarded to the controller 202 where they may be interpreted and used to generate responsive signals to local network interface 204, the television output 208, and/or the audio system 210.

The television output 208 may include circuitry to format media received from the local network interface 204 in a form suitable for transmission to a television. The television output 208 may provide an output in any useful digital or analog form, including, example, compressed or uncompressed HDTV, NTSC, or PAL signals. Physically, the television output 208 may include one or more of a composite video (RCA-style connector) output, an S-Video output, an RF output, a component video output, and a Digital Visual Interface (“DVI”) output. Optionally, signal processing may be performed by the controller 202, although allocation of functions for converting from the data type received at the local network interface 204 and the data type transmitted to the television output 208 is not important to the implementation of the systems described herein.

The audio output 210 may include a mono, an audio left and right channel, or the audio signals may be included with the television signals provided to the television output 208. Having separate audio output 208 may simplify installation with a stereo or other sound system, and may permit use of the on-demand system with audio media independent of visual media.

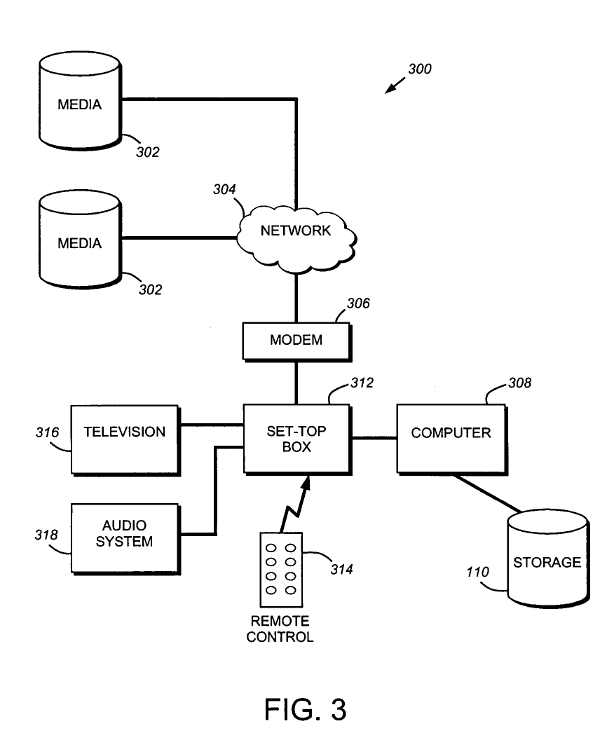

FIG. 3 is a block diagram of an on-demand media system. The system 300 of FIG. 3 is similar to the system 100 of FIG. 1 with differences as noted below, and may include one or more remote servers 302 storing media, a network 304, a modem 306, a computer 308 having a storage device 310 (which may be a distributed or independent storage device), a set-top box 312, a remote control 314, a television 316, and an audio system 318.

In the embodiment of FIG. 3, the modem 306 may connect directly to the set-top box 312. The set-top box 312 may connect to the computer 308 and storage device 110 through a separate network, or, for example, through a wireless local area network supported by the modem 306.

The set-top box 312 may execute an emulation process that emulates a computer that includes the storage device 310, such that reading from and writing to the storage device 310 appears externally to occur through the (emulated) computer's physical or local bus connection. This emulation may be readily achieved by those of ordinary skill in the art. The combined set-top box 312 and network-connected storage device 310 may thus appear to remote sites such as the remote servers 302 as a single logic board and processor. This emulation may be usefully employed where, for example, one of the remote servers 302 authenticates users based entirely or in part upon hardware configuration. Certain content providers may employ security of this type, but desire to provide content to users employing various hardware configurations such as the on-demand system shown above. By emulating a single computer, an authorized user may obtain content from the remote server 302 without requiring a redesign of digital rights management systems implemented on the remote server 302.

As another example of useful emulation that may be performed by the system, the set-top box 312 may be configured to emulate hardware and/or software that is used in the context of digital rights management. A digital rights management program may, for example, have minimum hardware requirements for recipients of media so that the distributor can ensure that distributed media is rendered with suitable quality (in addition to ensuring that only licensed users are viewing the media). At the same time, a particular user may have a system capable of the appropriate rendering—for example, a microprocessor within the set-top box 312 along with a high definition television—while having a computer 308 and/or storage device 310 that does not meet the minimum requirements. In such a case, the controller may usefully emulate an adequate, authorized system. A contemporary example is the Microsoft Windows XP Media Center Edition 2004, which is only licensed for use on certain platforms. If significant media becomes available for this architecture on the Internet, non-XP users may wish to access the media for home viewing. To allow this, the set-top box 312 may emulate the Media Center platform through a software layer that employs the corresponding Application Programming Interface (API) and associated function calls, as well as any hardware required to obtain the license or use the Media Center. In another embodiment, the set-top box 312 may include its own storage device, and may be used in this arrangement to emulate a Media Center computer.

Other configurations of a media on-demand system are possible that employ a minimal set-top box in combination with resources readily available at a consumer location. For example, if a consumer has network attached storage (“NAS”) or other storage as a stand-alone device connected to a home local area network, then the stand-alone device may be used for storage without the requirement for a computer, provided suitable control capability is programmed into the set-top box. In addition, various packaging options exist for the set-top box. For example, the functionality of the set-top box may be integrated into a television set, or into a DVD player or other consumer electronics device. Similarly, the functionality of the set-top box may be integrated into a cable, DSL, or satellite modem, or a wireless hub, router, or access point. These and other physical configurations may be based upon the system architecture described above and are intended to fall within the scope of the systems described herein.

FIG. 4 is a flow chart showing operation of a controller for an on-demand media system. It will be appreciated that the process 400 may be realized in hardware, software, any some combination of these suitable for controlling the components of the media on-demand systems described above. The process 400 may be realized in one or more microprocessors, microcontrollers, embedded microcontrollers, programmable digital signal processors or other programmable device, along with internal and/or external memory. The process 400 may also, or instead, include an application specific integrated circuit, a programmable gate array, programmable array logic, or any other device that may be configured to process electronic signals. It will further be appreciated that the above process 400 may be realized as computer executable code created using a structured programming language such as C, an object oriented programming language such as C++, or any other high-level or low-level programming language (including database programming languages and technologies) that may be compiled or interpreted to run on one of the above devices, as well as heterogeneous combinations of processors, processor architectures, or combinations of different hardware and software.

As indicated in the diagram, the process 400 may operate continuously while the system is powered on. Beginning with step 402, a user may search for content. Searching options may be provided within a user interface generated by the controller and embedded in television signals for display on a connected television. The user may navigate among options and enter alphanumeric search terms using any suitable techniques. Searching may be conducted on any meta-data associated with the data in the remote servers, such as titles, actors, length, content type (e.g., drama, action, romance, horror), media type (e.g., music, video), rendering quality, length, release dates, or any other information.

Once a search is entered, the controller generates suitable instructions to the computer (or to the network, where the controller is directly connected to, e.g., the Internet), which the computer may receive, interpret, and transmit over the network to one or more remote servers as a query. The storage device at the user location may also be accessed to determine if there is content that is only available locally. The local search results and the remote server search results may be combined. When search results are returned, they may be transmitted to the controller, which converts them into a form suitable for display on the television.

As shown in step 403, a user may then select content by operating the remote control to navigate within the user interface on the television screen.

As shown in step 404, the controller may then determine whether the selected content is already locally available by communicating (through the computer) with the storage device.

If the content is not locally available, the controller may coordinate retrieval of the content from a remote server, as shown in step 406. Depending upon the architecture of the system, this may occur through direct interaction between the controller and the remote server, or through the computer, under direction of the controller.

Once the content has been downloaded to the storage device, the content may be viewed as shown in step 408. If the content is locally available, then no download is required, and the process 400 may proceed directly from step 404 to step 408. Display of the content in step 408 may be controlled through a user interface rendered within the television display by the controller, as generally described above. A number of well known control options exist for display of media, such as play, pause, stop, restart, fast forward, reverse, step frame, and so on. In addition, interactive bookmarks may be provided so that a user can mark a place within media and return to the bookmark at a later time. When a user selects a control option from the user interface, the controller communicates with the storage device to retrieve and render corresponding portions of the content. During viewing, the controller retrieves data from the storage device and formats that data as necessary for display on the television.

It will be appreciated that the steps of the process 400 may be varied or supplemented, or their order modified, without departing from the systems described herein. For example, locally available content may be explicitly displayed in a separate section of a user interface such that no processing decision is required to determine whether selected content is locally available. As another example, with suitable modifications to the user interface, a user may search for content, as shown in step 402, while viewing other on-demand content, which is illustrated in FIG. 4 as a separate and discrete step 408. Any other known viewing, control, or searching techniques may be included in the above systems without departing from the scope of this disclosure. For example, previews of a number of content selections may be viewed in separate windows within the television in a user interface that permits selection of one of the windows for a full view.

The architecture, components, user interfaces, and methods described above, along with other systems and features, may additionally be employed. Thus, there is described an on-demand multi-media system for home use, as well as methods for operating a home on-demand media system based upon content available through a network such as the Internet. While the system has been described with reference to particular embodiments thereof, numerous modifications and variations will be apparent to those of ordinary skill in the art and are intended to fall within the scope of the inventions described herein. Thus, the invention set forth in the following claims is to be interpreted in the broadest sense allowable by law.

1. A system comprising:
a storage device;
a controller connected to the storage device through a first network connection, a television output, a remote control receiver, and a processor configured to receive instructions through the remote control receiver, to retrieve content from the storage device, and provide corresponding signals to the television output; and
an interface to a second network.

2. The system of claim 1 further comprising a remote server accessible through the interface to the second network, the remote server storing content organized as one or more media files, the system configured to retrieve content from the remote server and store the content on the storage device.

3. The system of claim 2 wherein the interface to the second network connects the second network to a computer including the storage device.

4. The system of claim 2 wherein the interface to the second network connects the second network to the controller, the controller storing the retrieved content on the storage device.

5. The system of claim 2 wherein the remote server includes a website that provides the content.

6. The system of claim 5 wherein the controller emulates a computer running software to interact with the website

7. The system of claim 5 wherein the controller emulates a computer that includes the storage device.

8. The system of claim 2 wherein the content on the remote server includes one or more movies.

9. The system of claim 2 wherein the content on the remote server includes at least one of news, music, television shows, games, music videos, or sports events.

10. The system of claim 1 wherein the controller is integrated into a television set.

11. The system of claim 1 wherein the controller is integrated into a set-top box.

12. The system of claim 11 wherein the set-top box includes a satellite receiver.

13. The system of claim 11 wherein the set-top box includes a cable receiver.

14. The system of claim 1 wherein the controller is integrated into at least one of a video cassette recorder, a digital versatile disc player, a digital video recorder, a wireless access point, a digital subscriber line transceiver, or a router.

15. The system of claim 1 wherein the controller generates a user interface within the signals to the television output, a user providing selections within the user interface rendered on a television set connected to the television output using a remote control connected in a communicating relationship with the remote control receiver of the controller.

16. The system of claim 1 further comprising:
a computer including the storage device;
a remote server connected to the second network; and
a television connected to the television output,
wherein the controller provides commands to the computer to download content from the remote server in response to input received from a user through a user interface rendered on the television.

17. The system of claim 16 wherein the interface to the second network is coupled to the controller, the controller receiving content from the remote server and transmitting the content to the storage device.

18. The system of claim 1 further comprising:
a computer including the storage device;
a remote server connected to the second network; and
a television connected to the television output,
wherein the controller provides content from the computer to the television in response to input received from a user through a user interface rendered on the television.

19. The system of claim 1 wherein the television output provides high-definition television signals.

20. The system of claim 1 wherein the remote control receiver includes an infrared interface.

21. The system of claim 1 wherein the remote control receiver includes a radio frequency interface.

22. The system of claim 21 wherein the radio frequency interface includes a Bluetooth interface.

23. The system of claim 1 wherein the interface to the second network includes a broadband connection.

24. Computer executable code embodied in a computer readable medium comprising:
computer executable code for operating a controller to retrieve content from a remote server and store the content on a storage device connected to the controller through a local network;
computer executable code for retrieving the content from the storage device and displaying the content on a television connected to the controller; and
computer executable code for generating a user interface on the television to control retrieval and display of the content on the television.

25. The computer executable code of claim 24 further comprising:
computer executable code for retrieving content from the remote server to the controller and transferring the content to the storage device.

26. The computer executable code of claim 24 further comprising:
computer executable code for operating a computer connected through the local network to the controller and including the storage device such that the computer downloads the content from the remote server and stores the content on the storage device.

27. A system comprising:
a computer including a storage device that stores content organized as one or more media files; and
a controller comprising a television output, a control interface, and a wireless interface, the control interface adapted to receive control signals for operation of the controller, and the wireless interface connected in a communicating relationship with the computer, the controller configured to retrieve the stored media from the computer through the wireless interface and provide signals to the television output suitable for interpretation and display on a television set.

28. A system comprising:
a plurality of devices connected in a communicating relationship through a first network, a first one of the devices including a storage unit and a second one of the devices including a connection to a second network, the second one of the devices including an emulator that presents the plurality of devices to the second network as a single device including at least the storage unit of the first device.

29. The system of claim 28 wherein the first one of the devices is a personal computer.

30. The system of claim 28 wherein the connection to the second network includes a broadband connection.

31. The system of claim 28 wherein the first network includes a wireless network.
